(19) United States
(12) Patent Application Publication
(10) Pub. No.: US 2011/0255915 A1
(43) Pub. Date: Oct. 20, 2011

(54) Furniture bracket

(76) Inventors: Hsueh-Ping Chen, Dong Guan City (CN); Yueh-Hung Chen, Dong Guan City (CN)

(21) Appl. No.: 12/763,875

(22) Filed: Apr. 20, 2010

(51) Int. Cl. F16B 12/00

(52) U.S. Cl. 403/381

(57) ABSTRACT

A type of furniture bracket, having two components, which allows easy assembly and disassembly of furniture, such as a vanity, without the need for tools. The components being attached to a planar and end side of furniture panels, respectively; one component having a recess with a flared lower portion and the other component having a flared raised portion such that the flared raised portion is inserted into the recess and slid down into the flared portion of the recess, thus wedging the components together and forming a tight contact between the two panels.

### BACKGROUND OF THE INVENTION

1. Field of the Invention

The invention relates to a type of furniture bracket, having two components, which allows easy assembly and disassembly of furniture, such as a vanity, without the need for tools.

2. Description of the Prior Art

There are many known ways to assemble pieces of furniture, including screws, nails, bolts, glue and other tool intensive fasteners. There are also many known ways to attach two or more pieces of wood to each other, including tongue and groove, mortise and tenon joints and sliding dovetail joints, all of which provide strong and secure joints. All of these, however, require tools of some sort, and many result in permanent or irremovable joints.

### SUMMARY OF THE INVENTION

The functionality of the furniture bracket is based on designing a piece of furniture, such as a vanity with multiple wooden sides or panels that require assembly. In designing the piece of furniture, a concave component is attached in a cavity of an inside face of one panel and a raised component is likewise attached in a cavity of an edge of an adjoining panel at the same relative position as the concave component, such that, after assembly, the two components would be aligned. The wooden panel with the concave component allows the raised component to slide in to the concavity and join the two wooden panels. This allows consumers to easily assemble and disassemble the piece of furniture without tools.

The bracket components include a concave part and a raised part, each of which is attached to an adjoining panel in such a way as to allow the raised part to be inserted into the concave part, sliding into a locked position, thereby securely attaching the two panels together. The panels can easily be taken apart by reversing those steps, that is, by sliding the panels in the opposite direction, which will unlock the bracket components, allowing the panels to separate easily and without damage to either panel or the bracket components.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a perspective view illustrating the concave component;

FIG. 2 is a perspective view illustrating the raised component;

FIG. 3A illustrates the concave component in use in a wooden panel;

FIG. 3B illustrates the raised component in use in a wooden panel;

FIG. 4 illustrates the joining of the two wooden panels.

### DETAILED DESCRIPTION OF DRAWINGS

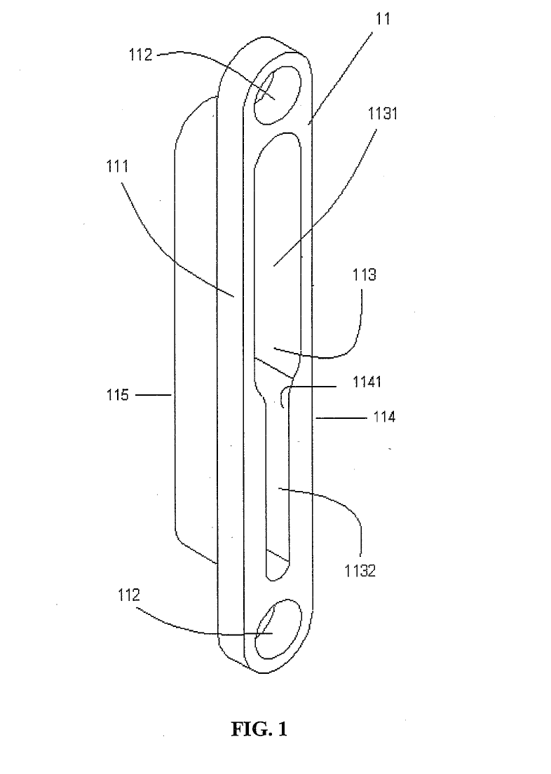

Referring to FIG. 1, a concave component 11 is shown with a recess groove 113, a front portion 114 and a back portion 115, and a pair of holes 112 situated at each end of the front portion 114. The front portion 114 has the recess groove 113 situated between the two holes 112 about 0.25 inches to 0.375 inches from each hole 112. The recess groove 113 has a uniform depth. The recess groove 113 has a wider upper opening 1131 and a narrower lower opening 1132, the wider upper opening 1131 having a uniform width, the narrower lower opening 1132 flaring into the recess groove 113 from the front portion 114 to the back portion 115 such that the narrower lower opening 1132 has a narrower width 1141 at the front portion 114 than the width of the wider upper opening 1131 and the same width at the back portion 115 as the wider upper opening 1131. The concave component 11 is preferably a single piece and is made out of a durable material, such as polyvinyl chloride (PVC), although any durable material can be used.

The pair of holes 112 may be beveled to allow for flush attachment of the concave component 11 to a board panel.

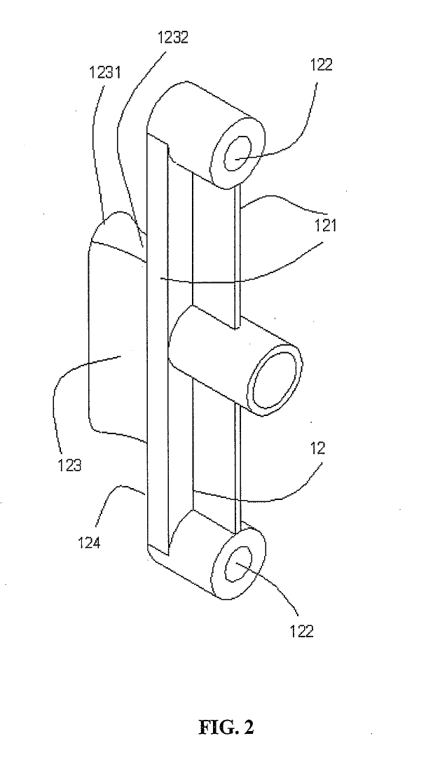

Referring now to FIG. 2, a raised component 12 is shown with a tongue portion 123, two sides 121, a face portion 124 and a pair of holes 122 situated at each end of the face portion 124. The tongue portion 123 has an inward section 1232 and an outward section 1231. The tongue portion 123 extends from the face portion 124 and is equidistant from the two sides 121. The tongue portion 123 is flared outward from the face portion 124 such that the inward section 1232 is narrower than the outward section 1231. The raised component 12 is preferably a single piece and is made out of a durable material, such as polyvinyl chloride (PVC), although any durable material can be used.

The pair of holes 122 may be beveled to allow for flush attachment of the face portion 124 of the raised component 12 to a board panel.

The width of the outward section 1231 is slightly less than the width of the wider upper opening 1131, and the width of the inward section 1232 is slightly less than the narrower width 1141 at the front portion 114 of the concave component 11.

In practice, the bracket attaches two panels, such as of a bathroom vanity, together at a ninety-degree angle. The concave component 11 is fixedly attached to a planar side of a panel by creating a mortise of sufficient depth into the planar side of the panel and inserting the concave component 11 such that the front portion 114 is flush with the planar side of the panel. The concave component 11 is preferably fixedly attached by screws through the holes 112 however any attaching means may be used. The raised component 12 is likewise fixedly attached to an end side of a panel by creating a mortise of sufficient depth into the end side of the panel and inserting the raised component 12 such that the face portion 124 is flush with the end side of the panel. The raised component 12 is preferably fixedly attached by screws through the holes 122 however any attaching means may be used.

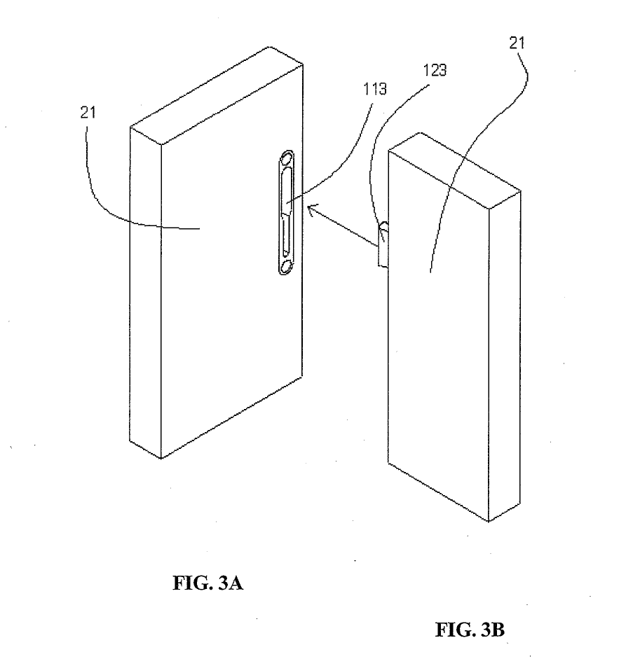

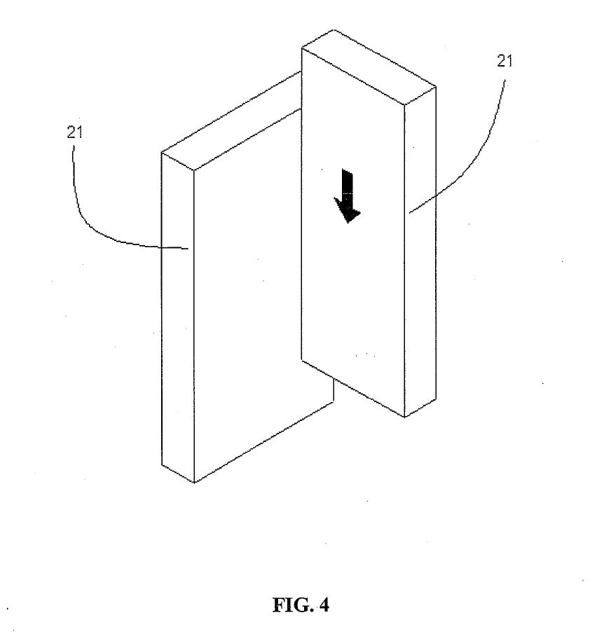

Referring now to FIGS. 3A and 3B, in attaching the two panels together, the tongue portion 123 is inserted into the recess groove 113 at the wider upper opening 1131 and slid down the recess groove 113 into the narrower lower opening 1132, the tongue portion 123 thereby becoming tightly wedged into the narrower lower opening 1132 and drawing the planer and end sides of the panels flush together as shown in FIG. 4.

We claim:

1. A furniture bracket comprising a single piece concave component and a single piece raised component,
the concave component comprising a recess groove, a front portion, a back portion, and a first pair of holes situated at each end of the front portion,
the recess groove being disposed in the front portion between the first pair of holes and having a uniform depth, a wider upper opening, and a narrower lower opening,
the wider upper opening having a uniform width,
the narrower lower opening flaring into the recess groove from the front portion to the back portion such that the narrower lower opening has a narrower width at the front portion than the width of the wider upper opening and the same width at the back portion as the wider upper opening,
the raised component comprising a tongue portion, two sides, a face portion and a second pair of holes situated at each end of the face portion ,
the tongue portion extending from the face portion and situated equidistant from the two sides, having an inward section and an outward section, and having a substantially flared shape outward from the face portion such that the inward section is narrower than the outward section,
whereby the concave component is fixedly attached at the first pair of holes to a planar side of a panel by creating a mortise of sufficient depth into the planar side of the panel and inserting the concave component such that the front portion is flush with the planar side of the panel, and the raised component is likewise fixedly attached at the second pair of holes to an end side of a panel by creating a mortise of sufficient depth into the end side of the panel and inserting the raised component such that the face portion is flush with the end side of the panel and in attaching the two panels together, the tongue portion is inserted into the recess groove at the wider upper opening and slid down the recess groove into the narrower lower opening, the tongue portion thereby becoming tightly wedged into the narrower lower opening thus drawing the planer and end sides of the panels flush together.

2. The bracket of claim 1 wherein the concave component and the raised component are made of a durable material.

3. The bracket of claim 1 wherein the concave component and the raised component are made of polyvinyl chloride.

4. The bracket of claim 1 wherein the first and second pairs of holes are beveled to allow for flush attachment of the concave component 11 to a board panel.

5. The bracket of claim 1 wherein the width of the outward section is slightly less than the width of the wider upper opening and the width of the inward section is slightly less than the narrower width at the front portion of the concave component.
